(19) United States
(12) Patent Application Publication
(10) Pub. No.: US 2007/0263019 A1
(43) Pub. Date: Nov. 15, 2007

(54) INFORMATION MANAGEMENT METHOD AND INFORMATION MANAGEMENT SYSTEM

(76) Inventors: Naohiro Furukawa, Tachikawa (JP); Hisashi Ikeda, Kunitachi (JP); Kosuke Konishi, Kokubunji (JP); Tsutomu Tashiro, Fujisawa (JP); Shoichi Nakagami, Miyoshi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/744,944

(22) Filed: May 7, 2007

(30) Foreign Application Priority Data
May 9, 2006 (JP) JP 2006-130392

(51) Int. Cl. B41J 29/38

(52) U.S. Cl. 347/5

(57) ABSTRACT

The invention has an object to guarantee, when rewritable paper is used, authenticity of information shown on the rewritable paper. Provided is an information management method for managing information concerning a medium executed in an information management system including: the medium capable of representing on a surface thereof object information that is contents concerning an object; a management apparatus for managing a history of operation on the medium; and a printing apparatus for representing the object information on the medium and erasing the represented object information from the medium, the information management method comprising: holding, by the management apparatus, a correspondence among an identifier of the medium, the object information represented on the medium, and a valid period of the object; and recording, by the management apparatus, a start of the valid period of the object when the printing apparatus represents the object information on the medium.

### CLAIM OF PRIORITY

The present application claims priority from Japanese patent application JP 2006-130392 filed on May 9, 2006, the content of which is hereby incorporated by reference into this application.

### BACKGROUND OF THE INVENTION

This invention relates to an information management system for managing a medium like a document, and more particularly, to a technology for managing a medium whose information is rewritable.

In recent years, more and more media (rewritable paper), whose information is rewritable, have been used. For instance, when the rewritable paper is applied to baggage tags in physical distribution, it becomes possible to use one sheet of paper multiple times, which contributes to conservation of the environment. Technologies for managing information mentioned on such baggage tags are proposed.

For instance, in JP 2004-302614 A, a contents sharing system is disclosed which includes a print device, an RFID read device, a client terminal, and a data storage management apparatus. In this contents sharing system, correspondences, in which ID codes of RFID tags of information indication media with RFID tag, on which contents information saved in the data storage management apparatus on a network has been printed, and the contents information have been associated with each other on a one-to-one basis, are registered in the data storage management apparatus. In response to a request to rewrite contents information on an information indication medium, an ID code is read from an RFID tag of the information indication medium, contents information corresponding to the ID code is searched from the data storage management apparatus, and the found contents information is printed on another information indication medium with RFID tag.

Also, in JP 2004-213372 A, a commodity management method is disclosed with which distribution information composed of various information generated by a distribution hub terminal at each distribution hub in a commodity distribution process is stored in a distribution DB. With this commodity management method, based on a search condition received from the distribution hub terminal, the distribution information corresponding to the search condition is searched from the distribution DB. This search condition includes at least a commodity code for identifying a commodity.

When such rewritable paper is used, however, it is possible to rewrite indication contents thereof, so there has been a problem that it is not guaranteed that the information indicated on the rewritable paper is correct information written by a user having proper authority. In particular, as compared with a case where ordinary paper is used, in the case of the rewritable paper, it is difficult to notice a situation where mentioned information has been tampered, so it is required to guarantee that the mentioned information is authentic.

This invention has an object to guarantee, when rewritable paper whose print contents are rewritable is used, authenticity of information shown on the rewritable paper.

### SUMMARY OF THE INVENTION

A representative aspect of this invention is as follows. That is, there is provided an information management method for managing information concerning a medium executed in an information management system including: the medium capable of representing on a surface thereof object information that is contents concerning an object; a management apparatus for managing a history of operation on the medium; and a printing apparatus for representing the object information on the medium and erasing the represented object information from the medium, the information management method comprising: holding, by the management apparatus, a correspondence among an identifier of the medium, the object information represented on the medium, and a valid period of the object; and recording, by the management apparatus, a start of the valid period of the object when the printing apparatus represents the object information on the medium.

According to a mode of this invention, it becomes possible to confirm whether object information shown on a medium is authentic.

### BRIEF DESCRIPTION OF THE DRAWINGS

The present invention can be appreciated by the description which follows in conjunction with the following figures, wherein:

FIG. 1 is a conceptual diagram showing processing by an information management system according to an embodiment of this invention;

FIG. 2 is an explanatory diagram showing a medium on which the information has been printed according to the embodiment of this invention;

FIG. 3 is a block diagram showing a configuration of an information management system according to a first embodiment of this invention;

FIG. 4 is an explanatory diagram showing a tag ID/object ID correspondence table according to the first embodiment of this invention;

FIG. 5 is an explanatory diagram showing an object information according to the first embodiment of this invention;

FIG. 6 is an explanatory diagram showing a print information according to the first embodiment of this invention;

FIG. 7 is a construction diagram showing an additional contents information according to the first embodiment of this invention;

FIG. 8A is an explanatory diagram showing a user information concerning a user according to the first embodiment of this invention;

FIG. 8B is an explanatory diagram showing a user information concerning another user according to the first embodiment;

FIG. 8C is an explanatory diagram showing a user information concerning another user according to the first embodiment;

FIG. 9 is an explanatory diagram showing a history information according to the first embodiment of this invention;

FIG. 10 is an explanatory diagram showing obtainment of relative coordinates on paper by the digital pen according to the first embodiment of this invention;

FIG. 11A is an explanatory diagram showing an example of a stroke set according to a first embodiment of this invention;

FIG. 11B is an explanatory diagram of the stroke information according to the first embodiment of this invention;

FIG. 12 is a flowchart showing tag print processing according to the first embodiment of this invention;

FIG. 13 is a flowchart showing a tag read processing according to the first embodiment of this invention;

FIG. 14 is a flowchart showing a tag write processing according to the first embodiment of this invention;

FIG. 15 is a flowchart showing a tag erasing processing according to the first embodiment of this invention;

FIG. 16 is a block diagram showing an information management system according to a second embodiment of this invention;

FIG. 17 is a flowchart showing offline a data conversion processing according to the second embodiment of this invention;

FIG. 18 is a detailed flowchart showing a offline data conversion processing according to the second embodiment of this invention.

FIG. 19 is a flowchart showing a preparation processing for common key encryption communication according to the embodiments of this invention;

FIG. 20 is a flowchart showing a preparation processing for public key/secret key encryption communication; and

FIG. 21 is a flowchart showing a processing for searching for a series of procedures concerning an object.

### DETAILED DESCRIPTION OF THE PREFERRED EMBODIMENTS

First, an outline of this invention will be described.

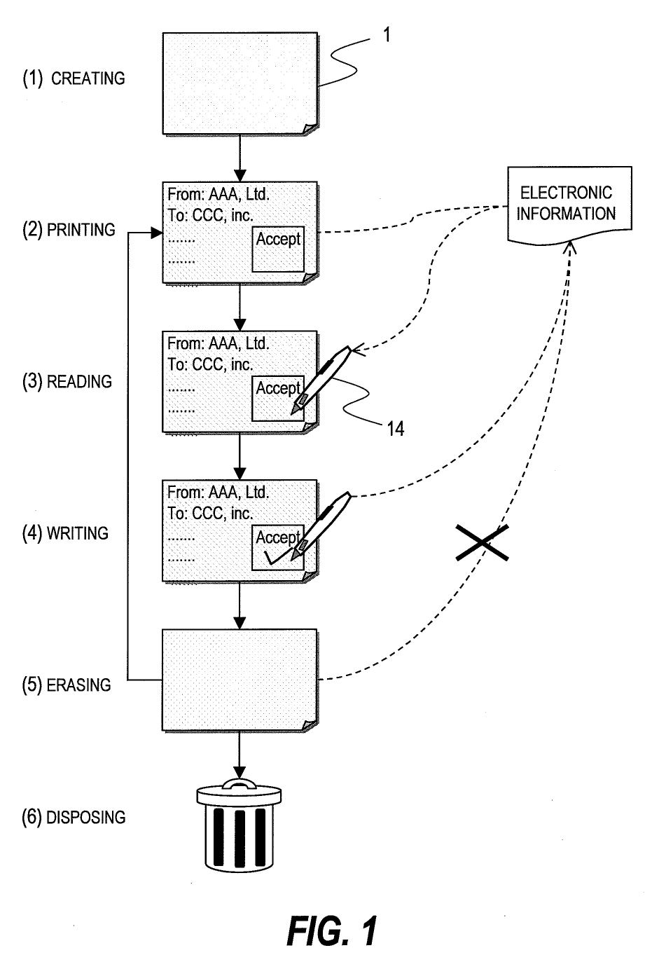

FIG. 1 is a conceptual diagram of processing by an information management system, to which this invention has been applied, and shows a life cycle of a rewritable medium in this invention.

This invention manages a medium, electronic information relating to information shown on the medium, a time of writing onto the medium, and a time of changing of a state of the medium by associating them with one another using means for identifying the medium and means for obtaining the information written on the medium. In addition to the information shown on the medium itself, electronic information managed in this invention includes additional content relating to the information shown on the medium.

First, a medium 1, to which a uniquely identifiable identifier (medium ID) has been given, is created. It is possible to print characters and the like on a surface of this medium 1 and erase the characters and the like from the medium surface (1). It is possible to uniquely identify this medium. For instance, as this medium, it is possible to use paper to which a dot pattern that is recognizable by a digital pen has been given. Also, it is possible to use a wireless tag whose identifier is readable by a read device. Further, it is possible to use a two-dimensional barcode printed on paper.

In addition, as a method of printing and erasing information printed on the medium, it is possible to use a technique with which switching between a color development state and a color erased state is achieved based on a cooling speed after heating using a leuco dye. Also, it is possible to use an erasable ink (e-blue, for instance) with which switching from a color development state to a color erased state is performed by cutting a binding between a color former and a coloring matter through heating and binding a color erasing agent and the coloring matter with each other.

In this embodiment, as means for obtaining the medium ID, a digital pen is used. When the digital pen is used, it becomes possible to use an identifier (dot pattern ID) of a dot pattern on the medium obtained with the digital pen as the medium ID.

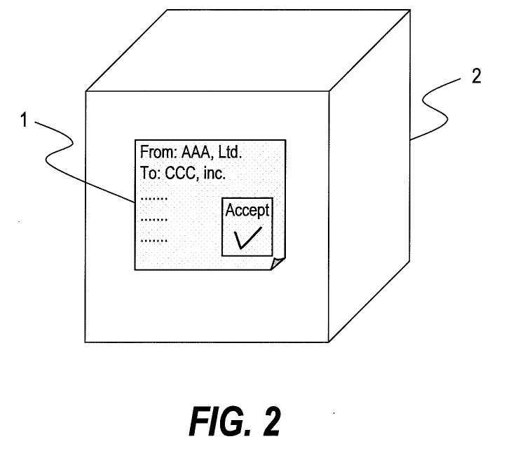

After that, some information is printed on the created medium. In this case, the medium 1 (medium ID) and electronic information (print source file and additional contents, for instance) relating to the contents printed on the medium are linked to each other (2). For instance, as shown in FIG. 2, the medium 1, on which the information has been printed, is affixed to a commodity 2 as a label and is used for identification of the commodity.

Following this, in course of distribution, the medium ID is obtained by touching the medium using a digital pen 14, an inquiry is issued to a server based on the obtained medium ID, and the linked electronic information is obtained (3). In this case, the electronic information may be provided after it has been confirmed that an operator has a right to obtain the electronic information. It is possible for the operator to confirm that the information printed on the medium is authentic by checking the obtained electronic information and the information printed on the medium against each other.

Then, after information has been written on the medium using the digital pen 14, the electronic information is updated to reflect the written information (4). Also when the information is written, after it has been confirmed that the operator has a right to obtain the electronic information, the electronic information is updated to reflect the written information.

Next, when the information printed on the medium and the written information are erased, the medium becomes reusable. In this case, the link between the medium ID and the electronic information is cut (5). It is possible to use the medium, whose information has been erased and link with the electronic information has been cut, by printing information in (2) again.

After that, when the medium undergoes writing and erasing many times, it becomes impossible to cleanly erase information on the medium, so the medium is disposed. In this case, it is stored that the medium has been disposed (6).

In other words, in this invention, during a period from a time (2), at which the information has been printed on the medium, to a time (5) at which the information has been erased from the medium, the medium ID and the electronic information concerning the information shown on the medium are linked with each other.

In other words, in an embodiment of this invention, the medium and the electronic information concerning the information shown on the medium are associated with each other and are managed using means for identifying the medium such as a combination of a digital pen and a dot pattern. In addition, the medium and the information written on the medium are associated with each other and are managed using hand-written information obtainment means. Then, when the information is printed on the medium, the medium and the electronic information are linked with each other. Also, when the information is erased from the medium, the link between the medium and the electronic information is removed.

Next, embodiments of this invention will be described with reference to the accompanying drawings.

### First Embodiment

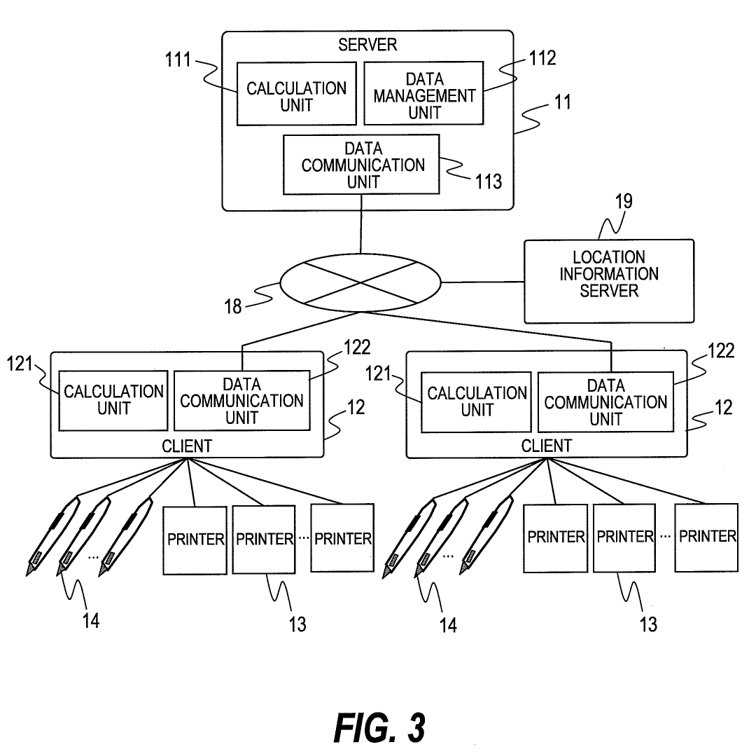

FIG. 3 is a block diagram showing a construction of an information management system according to a first embodiment.

The information management system in the first embodiment includes a server 11, client terminals 12, digital pens 14, a network 18, and a location information server 19.

The server 11, the client terminals 12, and the location information server 19 are connected to one another through the network 18. The client terminals 12 and the digital pens 14 are connected in a wireless manner based on Bluetooth, a wireless LAN, a mobile telephone system, infrared rays, or the like. Alternatively, the client terminals 12 and the digital pens 14 may be connected in a wired manner using a universal serial bus (USB) protocol or the like.

The server 11 manages information concerning media and provides the client terminals 12 with the information concerning the media. The server 11 includes a calculation unit 111, a data communication unit 112, and a data management unit 113. The calculation unit 111 includes a CPU and a memory. The CPU invokes and executes various programs, thereby performing computation concerning processing carried out at the server 11.

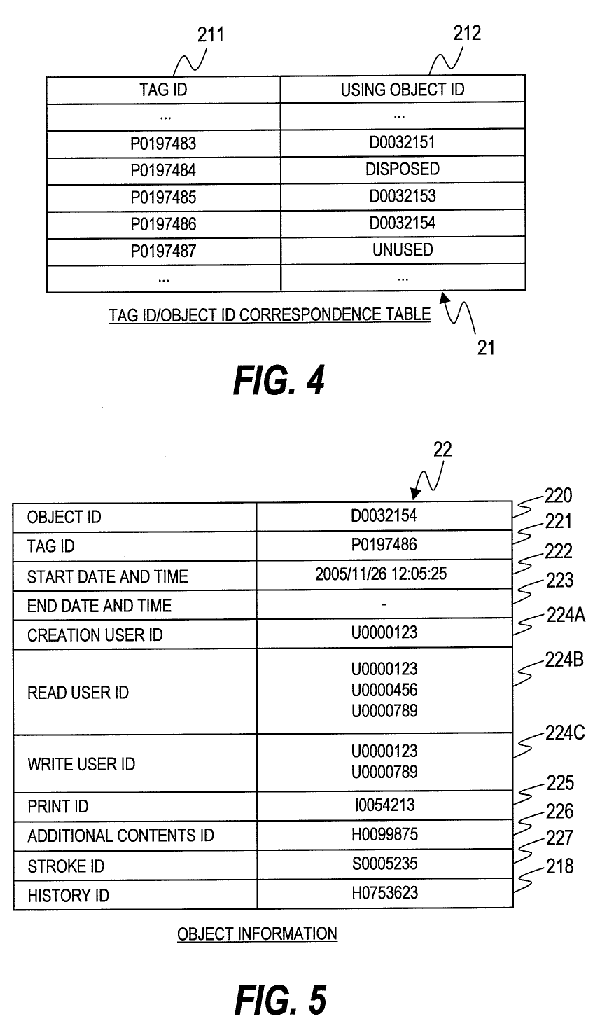

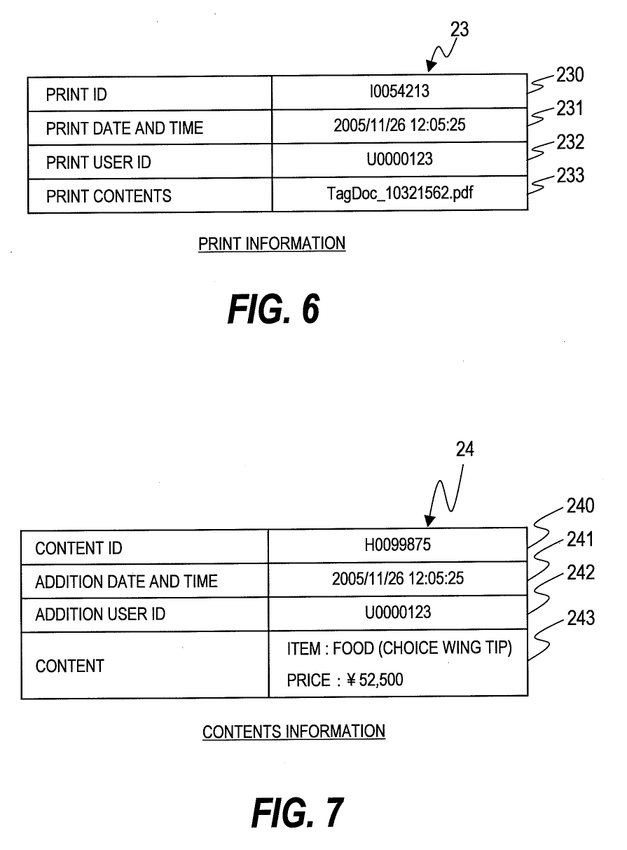

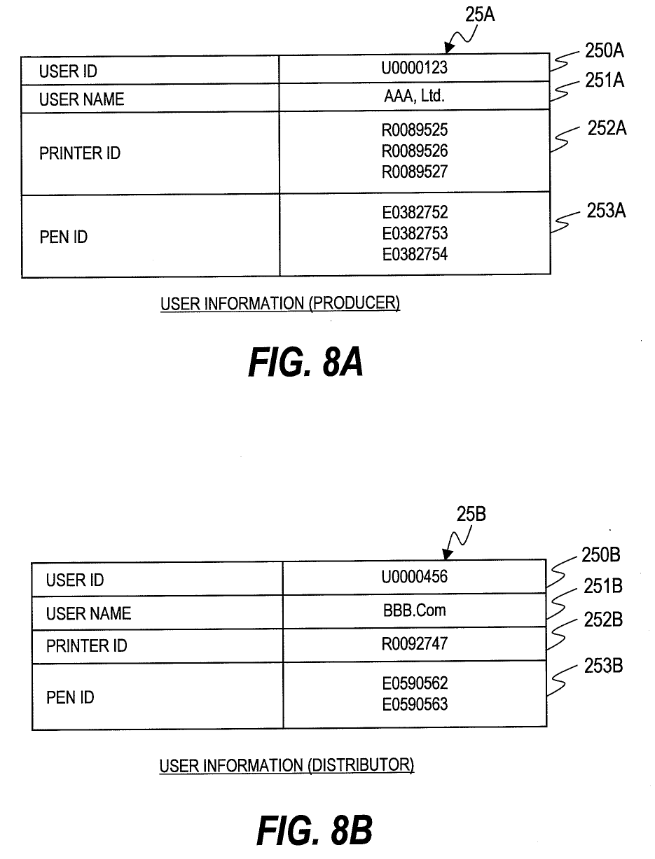

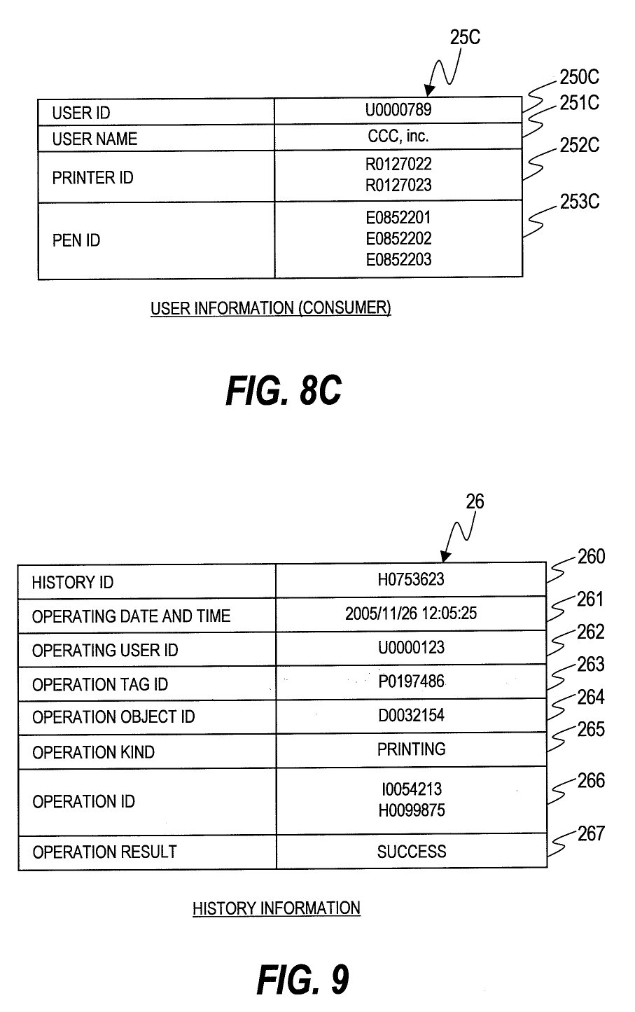

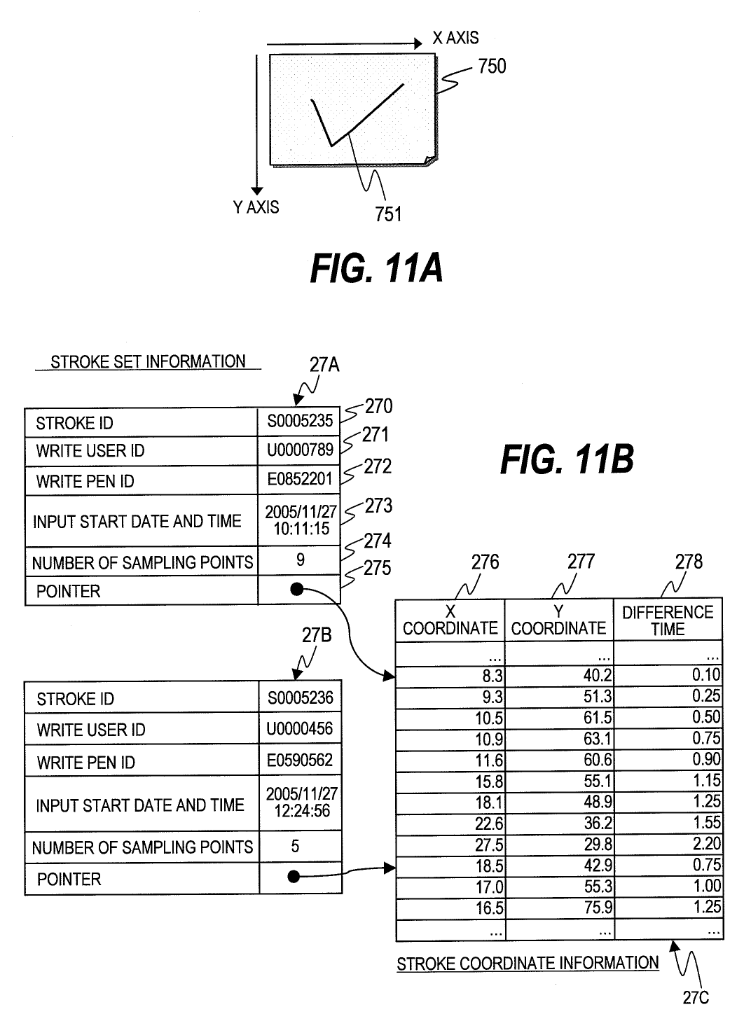

The data management unit 113 is constructed by a nonvolatile storage medium (magnetic disk drive, for instance) and stores the various programs executed at the calculation unit 111. Also, the storage unit 113 stores a tag ID/object ID correspondence table 21 as shown in FIG. 4, object information 22 as shown in FIG. 5, print information 23 as shown in FIG. 6, additional contents information 24 as shown in FIG. 7, user information 25A and the like as shown in FIG. 8A, FIG. 8B, and FIG. 8C, history information 26 as shown in FIG. 9, and stroke information 27 as shown in FIG. 11B.

The data communication unit 112 includes a network interface. The network interface is a LAN card that is capable of performing communication using a TCP/IP protocol, for instance. The server 11 is capable of communicating with a device connected to the network 18, such as the client terminal 12, through the network interface.

Each client terminal 12 is a computer device used by a user and transfers information received from each digital pen 14 to the server 11. To the client terminal 12, printers 13 are connected.

The client terminal 12 includes a calculation unit 121, a data communication unit 122, a pen input unit (not shown), an operation input unit (not shown), and a data display unit (not shown). The calculation unit 121 includes a CPU and a memory. The CPU invokes and executes various programs, thereby performing computation concerning processing carried out at the client terminal 12.

The data communication unit 122 is a network interface and is, for instance, a LAN card that is capable of performing communication using a TCP/IP protocol. With this construction, the client terminal 12 is capable of performing communication with the server 11 through the network 18.

The pen input unit is connected with the digital pen 14 in a wireless manner (in accordance with Bluetooth or a wireless LAN, for instance) or a wired manner (using a USB protocol, for instance) and collects information about coordinates and the like obtained by the digital pen 14. It should be noted that the pen input unit and the data communication unit 122 may be the same interface.

The operation input unit is a keyboard, for instance, and is used by a user to input information. The data display unit is constructed using a liquid crystal display, for instance, and displays information concerning a medium obtained from the server 11.

Each printer 13 prints information including a predetermined dot pattern on a medium according to an instruction from the client terminal 12. As shown in FIG. 2, this medium, on which the information has been printed, is used as a label affixed to a commodity.

Like in the case of an ordinary pen, with the digital pen 14, it is possible to annotate characters, figures, and the like to a paper medium. Also, the digital pen 14 includes a micro-camera at its tip end and obtains image information of a dot pattern printed on the paper. Further, the digital pen 14 holds a pen ID set in advance. Still further, the digital pen 14 includes a communication interface for connection with the client terminal 12 in a wireless or wired manner.

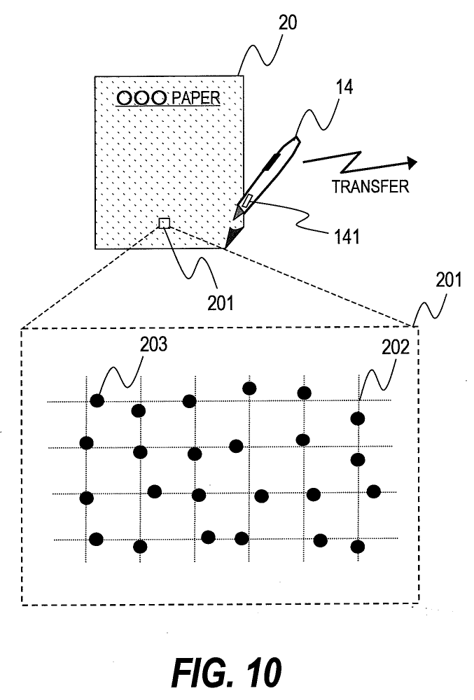

For instance, as shown in FIG. 10, the digital pen 14 obtains dot pattern information printed on a document. It is possible to calculate coordinates in a dot pattern space from this dot pattern information. Also, it is possible to identify coordinates on a paper plane from the dot pattern information obtained by the digital pen 14 by referring to the location information server 19.

It should be noted that it is also possible for the digital pen 14 to transmit, through a mobile telephone system or a wireless LAN system, the identified absolute coordinates, a time at which the dot pattern has been obtained, and the pen ID directly to the server 11 not through the client terminal 12.

The location information server 19 is a computer device including a CPU, a memory, a storage device and the like. The location information server 19 holds a database on which the absolute coordinates in the dot pattern space calculated by the digital pen 14 and the coordinates on the paper plane are associated with each other, and provides the coordinates on the paper plane based on the dot pattern on the paper plane.

FIG. 4 is a construction diagram of the tag ID/object ID correspondence table 21 according to the first embodiment.

The tag ID/object ID correspondence table 21 is information storing relations between media and information shown on the media and states of the media, and is stored in the data management unit 112 of the server 11. The tag ID/object ID correspondence table 21 contains, for each medium, a tag ID 211 and a used object ID 212.

The tag ID 211 is a unique identifier of the medium. The used object ID 212 is a unique identifier of information shown on the medium. Attributes of the information identified by the object ID are recorded in the object information 22. With the object ID, it is possible to identify the information printed on a surface of the medium as well as additional contents as shown in FIG. 7 relating to the information printed on the surface of the medium.

As the used object ID 212, a state (“disposed” or “unused”) of the medium is stored as well.

In other words, when the used object ID 212 is set at “disposed”, this means that the medium having the tag ID has been physically disposed. Therefore, by newly creating a medium having the same tag ID, it becomes possible to use this tag ID again. In this embodiment, even when the medium has been disposed, the tag ID is not deleted but data of the tag ID may be deleted.

Also, when the used object ID 212 is set at “unused”, this means that the tag exists but is not used. More specifically, it is meant that the medium has been created but has never been used or the medium was used in the past but information has been erased, and therefore the used object ID has been erased.

With the tag ID 211 and the used object ID 212 listed on the tag ID/object ID correspondence table 21, it is possible to find a relation between the medium and the information shown on the medium. Also, the tag ID 211 and the used object ID 212 have a one-to-one relation at all times. In other words, the number of media possessing the tag ID is only one and the number of tags associated with the object ID is only one at all times.

Then, through printing of the information on the surface of the medium, the tag ID 211 and the object ID 212 are linked with each other. Also, when the printed information is erased from the medium, or the medium, on which the information has been printed, is disposed, the link between the tag ID 211 and the object ID 212 is removed.

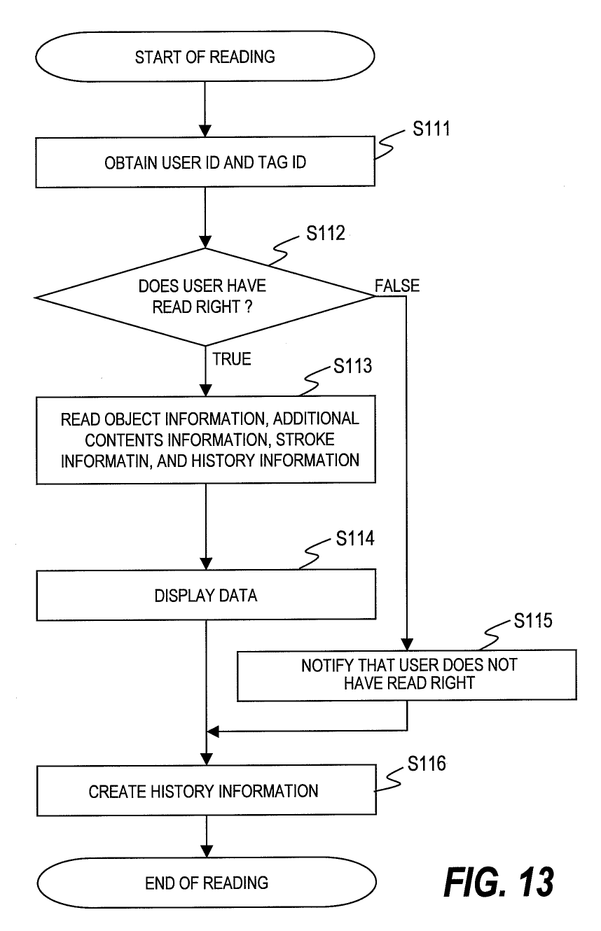

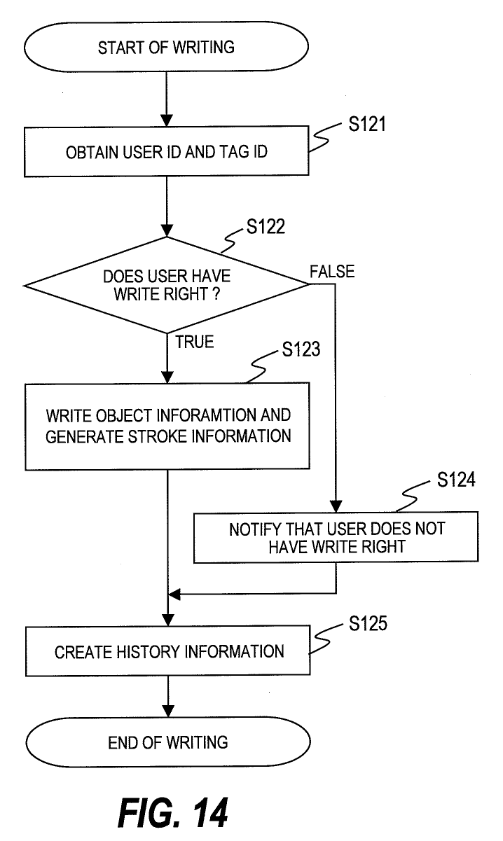

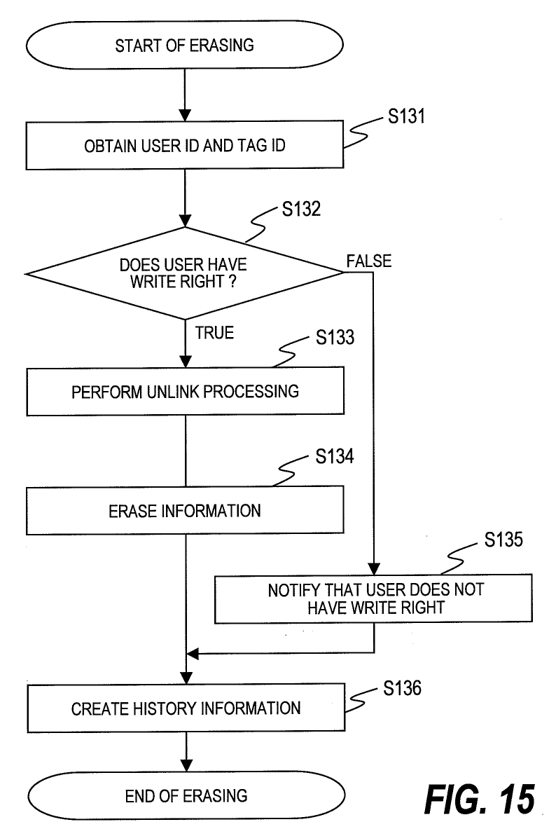

Therefore, in read processing shown in FIG. 13, write processing shown in FIG. 14, and erase processing shown in FIG. 15 to be described later, the object ID 212 is identified from the tag ID 211 and other information (object information 22 shown in FIG. 5, print information 23 shown in FIG. 6, additional contents information 24 shown in FIG. 7, user information 25 shown in FIG. 8A to FIG. 8C, history information 26 shown in FIG. 9, and stroke information 27 shown in FIG. 11B) are searched for, so when the tag ID 211 and the used object ID 212 are not linked with each other on the tag ID/object ID correspondence table 21, it is impossible to search for these information. The tag ID/object ID correspondence table 21 holds a link relation between the tag ID 211 and the used object ID 212 at a current time. Therefore, when the link between the tag ID and the used object ID is already removed, it is required to search for these information by referring to the object information 22 described below.

FIG. 5 is a construction diagram of the object information 22 according to the first embodiment.

The object information 22 is information storing an attribute of each object and is stored in the data management unit 112 of the server 11. The object information 22 contains an object ID 220, a tag ID 221, a start date and time 222, an end date and time 223, a creation user ID 224A, at least one read user ID 224B, at least one write user ID 224C, a print ID 225, an additional contents ID 226, a stroke ID 227, and a history ID 228.

The object ID 220 is a unique identifier of information shown on a medium. The tag ID 221 is a unique identifier of the medium on which the information identified with the object ID has been shown. As the object ID 220 and the tag ID 221, a pair that is the same as the pair of the used object ID 212 and the tag ID 211 recorded on the tag ID/object ID correspondence table 21 is recorded.

The start date and time 222 is a date and time of printing of the information identified with the object ID on the medium. The end date and time 223 is a date and time of erasing of the information identified with the object ID from the medium. In other words, a period from the start date and time 222 to the end date and time 223 is a valid period of indication of the information identified with the object ID on the medium.

The creation user ID 224A is a unique identifier of a user who printed the information identified with the object ID on the medium. Each read user ID 224B is a unique identifier of a user who is permitted to read information (additional contents or the like) relating to the information identified with the object ID. Each write user ID 224C is a unique identifier of a use who is permitted to change the information identified with the object ID. It should be noted that in this example, multiple read user IDs 224B and multiple write user IDs 224C are registered, each user having a right with respect to each processing.

The print ID 225 is a unique identifier of the information printed on the surface of the medium and is a link to the print information 23 as shown in FIG. 6. The print ID 225 is additionally recorded when information is overprinted on the medium (information is further printed without erasing already printed information).

The additional contents ID 226 is a unique identifier of additional contents accompanying the information printed on the surface of the medium and is a link to the additional contents information 24 as shown in FIG. 7.

The stroke ID 227 is a unique identifier of information (stroke set) hand-written on the surface of the medium and is a link to the stroke information 27 as shown in FIG. 11B. When information is written on the medium, the stroke ID 227 is additionally recorded.

Each stroke set is a collection of mutually related lines (strokes) and is obtained using layout analysis in character recognition, for instance. In the layout analysis, the mutually related lines are identified based on times, at which the lines have been annotated, and/or positional relations among the lines, thereby obtaining the stroke set. In other words, strokes annotated at near times and near locations constitute one stroke set.

The history ID 228 is a link to the history information 28 as shown in FIG. 9 showing a history of operation of the information identified with the object ID.

FIG. 6 is a construction diagram of the print information 23 according to the first embodiment.

The print information 23 is information concerning contents printed on a medium and is stored in the data management unit 112 of the server 11. The print information 23 contains a print ID 230, a print date and time 231, a print user ID 232, and print contents 233.

The print ID 230 is a unique identifier determined for each print processing onto the medium. The print date and time 231 is a date and time of printing of information onto the medium. The print user ID 232 is a unique identifier of a person who printed the information on the medium. The print contents 233 are a unique identifier of the contents printed on the medium and are a file name of electronic data printed.

FIG. 7 is a construction diagram of the additional contents information 24 according to the first embodiment.

The additional contents information 24 is information concerning additional contents accompanying information shown on a medium and is stored in the data management unit 112 of the server 11. The additional contents information 24 contains an additional contents ID 240, an addition date and time 241, an addition user ID 242, and additional data 243.

The contents ID 240 is a unique identifier of the additional contents. The addition date and time 241 is a date and time of addition of the contents. The addition user ID 242 is a unique identifier of a person who added the contents.

The additional data 243 is the contents added to the information shown on the medium. It does not matter whether the additional data 243 is contents that are not printed on the medium or contents that overlap the contents printed on the medium.

FIG. 8A to FIG. 8C are each a construction diagram of the user information according to the first embodiment.

The user information 25A shown in FIG. 8A is information concerning a user, who uses the information management system according to this embodiment, and is stored in the data management unit 112 of the server 11. The user information 25A contains a user ID 250A, a user name 251A, at least one printer IDs 252A, and at least one pen IDs 253A.

The user ID 250A is a unique identifier of the user. The user name 251A is a name (or company name) of the user. Each printer ID 252A is a unique identifier of a printer 13 used by the user. Each pen ID 253A is a unique identifier of a digital pen 14 possessed by the user. In this embodiment, multiple printer IDs 252A and multiple pen IDs 253A are registered.

The user information 25A has been described above. Other user information 25B shown in FIG. 8B and user information 25C shown in FIG. 8C also contain the same items and are stored in the data management unit 112 of the server 11.

In this specification, three types of users are described as the user information 25A, 25B, and 25C. For instance, a user identified with “U0000123” is a producer of a commodity for which information has been printed (label has been created) on a medium. Also, a user identified with “U0000456” is a distributor of the commodity. Further, a user identified with “U0000789” is a consumer of the commodity.

Here, when the object information 22 is referred to, it is shown that the user “U0000123” is a creation user, so it can be understood that the user is a person who printed the information (created the label) on the medium. Also, the user “U0000123” is a read user and a write user, so he/she has a right to read additional contents and a right to write information.

On the other hand, the user “U0000456” is a read user but is not a write user, so he/she has a right to read the additional contents but does not have a right to write information on the medium and update the additional contents. Also, the user “U0000789” is a read user and is also a write user, so he/she has a right to read the additional contents and a right to write information.

By changing read and write right limitations from user to user in this manner, it becomes possible to prevent tampering of information in the course of distribution. In other words, even when information shown on a medium is tampered, it becomes possible for a user to confirm whether the information shown on the medium is authentic by obtaining electronic information relating to the information shown on the medium and checking the obtained electronic information and the information indicated on the medium against each other.

FIG. 9 is a construction diagram of the history information 26 according to the first embodiment.

The history information 26 is information concerning operation performed on a medium of this embodiment and is generated when any operation is performed on the medium. The history information 26 is stored in the data management unit 112 of the server 11 and contains a history ID 260, a operating date and time 261, a operating user ID 262, a operation tag ID 263, a operation object ID 264, a operation kind 265, at least one operation ID 266, and a operation result 267.

The history ID 260 is a unique identifier of operation. The operating date and time 261 is a date and time at which the operation has been performed. The operating user ID 262 is a unique identifier of a user who performed the operation.

The operation tag ID 263 is a unique identifier of the medium that is a target of the operation. The operation object ID 264 is a unique identifier of information shown on the medium that is a target of the operation.

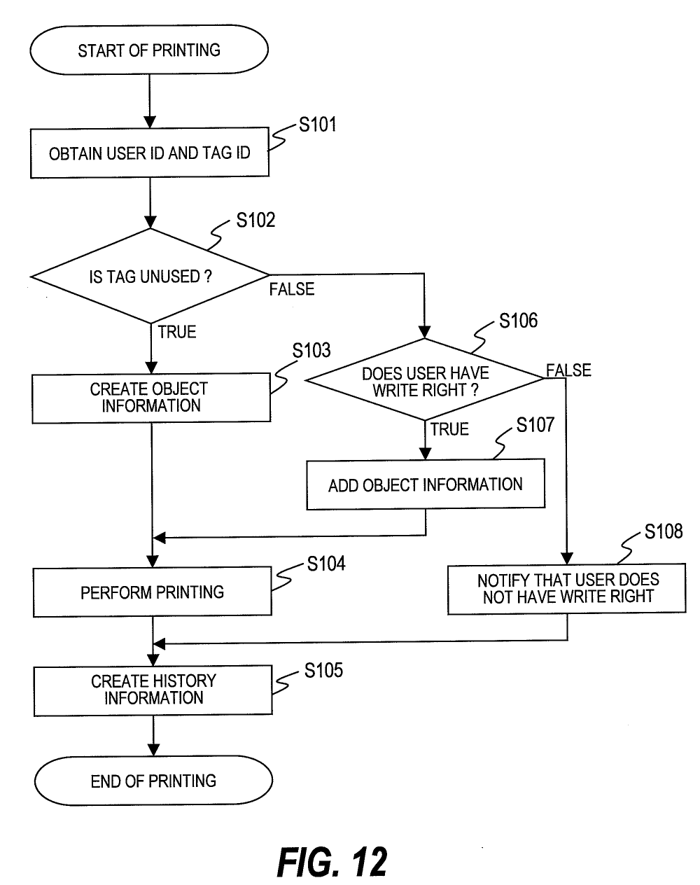

The operation kind 265 indicates a kind of the operation. There are various operation kinds 265 such as “print”, “read”, “write”, “erase”, and “disposal”. When print processing shown in FIG. 12 is carried out, “print” is recorded. When read processing shown in FIG. 13 is carried out, “read” is recorded. When write processing shown in FIG. 14 is carried out, “write” is recorded. When erase processing shown in FIG. 15 is carried out, “erase” is recorded.

Each operation ID 266 is information used in the operation. In an example shown in FIG. 9, it is recorded that printing identified with a print ID “I0054213” has been performed and additional contents identified with “H0099875” have been generated as a result of the printing. It should be noted that when the operation kind 265 is “write”, stroke information 27 is recorded as a operation ID 266.

The operation result 267 shows a result of the operation and “success” or “failure” is recorded.

FIG. 10 is an explanatory diagram of obtainment of relative coordinates on paper by the digital pen 14 according to the embodiment of this invention.

The digital pen 14 comprises a CPU, a memory, a communication interface, a camera 141, a battery, and a writing pressure sensor. Further, the digital pen 14 comprises a pen tip with which it is possible to write characters, symbols, and the like on paper with ink or graphite.

The digital pen 14 is used together with a medium (sheet) 20 on which dots 203 for location detection have been printed. Here, the dots 203 will be described by magnifying a part 201 of the sheet 20. On the sheet 20, multiple small dots 203 have been printed. Those dots 203 have been printed at locations displaced from intersections (reference points) 202 of virtual lattice lines upwardly, downwardly, rightwardly, or leftwardly.

When a character or a figure is annotated to the paper with the digital pen 14, the annotated character or the like remains on the paper in such a manner that visual recognition is possible. When detecting that the pen tip has contacted the paper using the writing pressure sensor, the digital pen 14 photographs the dots 203 printed on the paper with the camera 141. For instance, the digital pen 14 photographs an area containing six by six dots 203.

The digital pen 14 computes absolute coordinates, at which the dot pattern exists, from a combination of displacement manners of respective photographed dots. Those absolute coordinates are coordinates at which the dot pattern exists in a vast plane area. The vast plane area is an entire area in which arrangement of dot patterns without overlapping is possible.

The digital pen 14 transmits the computed absolute coordinates to the client terminal 12 through the digital pen interface 13. The client terminal 12 transmits the absolute coordinates transmitted from the digital pen 14 to the location information server 19. The location information server 19 identifies the location (dot pattern ID) of the paper in the vast plane area and coordinates (relative coordinates) on the paper sheet based on the absolute coordinates transmitted from the digital pen 14 and transmits the identified dot pattern ID and relative coordinates to the server 11.

In the manner described above, the server 11 obtains the dot pattern ID and the relative coordinates from the dot pattern photographed by the digital pen 14.

Through periodic obtainment (in units of a fixed time, for instance) by the digital pen 14 of information about contact locations of the pen tip, it is possible to find movement of the pen tip. Then, the digital pen 14 transmits the absolute coordinates corresponding to the photographed dot pattern, a photographed time of the dot pattern and the pen ID to the client terminal 12.

The server 11 obtains the relative coordinates from the location information server 19 based on the absolute coordinates computed by the digital pen 14. The server 11 generates a path (stroke information) of the pen tip from the obtained relative coordinates and the photographed time of the dot pattern.

It should be noted here that the location information server 19 may be included in the server 11 instead of being provided separately.

Also, it is not required for the digital pen 14 to use the location information server 19 in order to identify the dot pattern ID and the relative coordinates. For instance, the sheet identification may be achieved using an identification number printed on the paper, a barcode printed on the paper, or an IC tag embedded in the paper. In addition, it is possible to identify locations (relative coordinates) on the sheet using a tablet. It should be noted that one of the sheet identification using an IC tag or the like and the location identification on the sheet using the tablet may be combined with the absolute coordinate identification by the location information server 19. In this case, it becomes possible to alleviate a load of processing in which the document management system identifies the dot pattern ID and the relative coordinates.

FIG. 11A shows an example of a stroke set according to a first embodiment of this invention.

The stroke set shows a symbol “ [symbol] ” 751 annotated with the digital pen 14. In this embodiment, as shown in the drawing, a left upper corner is set as an origin, a horizontal direction is set as an X axis, and a vertical direction is set as a Y axis, thereby determining locations of the strokes. As described above, the stroke set is a collection of mutually related lines (strokes) and is identified based on written times of the lines and/or positional relations among the lines.

FIG. 11B is a construction diagram of the stroke information 27 stored in the server 11 according to the first embodiment of this invention.

The stroke information 27 contains stroke set information 27A and 27B and stroke coordinate information 27C.

The stroke set information 27A contains a stroke ID 270, a write user ID 271, a write pen ID 272, an input start date and time 273, the number of sampling points 274, and a pointer 275.

The stroke ID 270 is a unique identifier of the stroke set. The pen ID 272 is a unique identifier of the digital pen 14 used to annotate the stroke.

The input start date and time 273 is a date and time of start of annotation of the stroke set. The number of sampling points 274 is the number of points contained in the stroke. The digital pen 14 periodically obtains a location of its pen tip and the number of points obtained from the start to the end of the stroke is recorded. The pointer 275 is a pointer with respect to the stroke coordinate information 27C.

The stroke coordinate information 27C contains X coordinates 276, Y coordinates 277, and difference times 278.

Each X coordinate 276 is a relative coordinate in a direction of the X axis shown in FIG. 11A and is expressed in units of millimeters, for instance. Each Y coordinate 277 is a relative coordinate in a direction of the Y axis shown in FIG. 11A and is expressed in units of millimeters, for instance. Each difference time 278 expresses an obtainment time of the relative coordinates by the digital pen 14. It should be noted that as the difference time 278, an elapsed time from the input start date and time 273 is recorded.

Next, processing in the information management system according to the embodiment of this invention will be described.

FIG. 12 is a flowchart of tag print processing according to the first embodiment.

First, a user operates the client terminal 12 to input an instruction to print information on a medium. In this case, the user designates the medium, on which the information is to be printed, by reading a dot pattern printed on a surface of the medium with a touch of the medium using the digital pen 14. The digital pen 14 sends the read dot pattern to the client terminal 12.

The client terminal 12 transmits a print instruction containing an ID of the user, who operated the client terminal 12, and the dot pattern obtained by the digital pen 14 to the server 11.

On receiving the print instruction from the client terminal 12, the server 11 obtains the user ID contained in the received print instruction and obtains a tag ID from the dot pattern ID contained in the received print instruction (S101). In this case, when a medium is new on which nothing is printed, it is impossible to obtain a dot pattern from the medium with the digital pen 14. When it is impossible for the digital pen 14 to obtain a dot pattern, the server 11 generates a new tag ID.

The server 11 judges whether a print target medium is unused based on whether the digital pen 14 has obtained a dot pattern. In addition, the server 11 judges whether a state of the medium (print target medium) having the obtained tag ID is “unused” by referring to the tag ID/object ID correspondence table 21 (S102).

When it is found as a result of the judgment that the medium is unused, printing on the medium is possible, so the server 11 generates object information 22 to be printed on the medium, print information 23, and additional contents information 24 (S103). Then, the processing proceeds to step S104.

In step S104, the server 11 identifies a file recording contents to be printed by referring to the print contents 233 of the print information 23 and transmits a print command to the printer 13. Then, on receiving the print command, the printer 13 prints designated information on the medium (S104).

After that, the server 11 creates history information 26 in which “print” has been recorded as the operation kind 265. As the operation ID 266, the server 11 records the print ID 230 of the print information 23 generated in step. S104 (S105).

On the other hand, when it is not found in step S102 that the used object ID 212 is “unused”, the server 11 judges whether the user ID obtained in step S101 is contained as the write user ID 224C by referring to the object information 22 using an object ID 211 corresponding to the tag ID 211 (S106).

When it is found as a result of the judgment that the identifier of the user, who instructed the printing, is contained as the write user ID 224C, this means that the user has a right to change information indicated on the medium, so the server 11 adds the print ID 225 and the contents ID 226 of the object information 22 (S107). After that, the processing proceeds to step S104, in which the server 11 transmits a print command to the printer 13.

On the other hand, when it is not found in step S106 that the identifier of the user, who instructed the printing, is contained as the write user ID 224C, this means that the user does not have a right to change the information indicated on the medium, so the server 11 notifies the client terminal 12 that the user does not have a right to change the indicated information. On receiving the notification that the user does not have a right to read additional contents, the client terminal 12 displays, on the data display unit, that the user does not have a right to read the additional contents. It should be noted that the notification that the user does not have a read right may be issued to the user by vibrating the digital pen 14 and/or emitting a warning sound from the digital pen 14 (S108). After that, the processing proceeds to step S105, in which the history information 26 is created.

It should be noted that when it is found in step S102 that the used object ID 212 is “disposed”, this means that a print target medium should not exist, so the processing is terminated due to an error.

FIG. 13 is a flowchart of tag read processing according to the first embodiment.

First, a user operates the client terminal 12 to input an instruction to read additional contents relating to information shown on a surface of a medium. In this case, the user designates the medium, from which the information is to be read, by reading a dot pattern printed on the surface of the medium with a touch of the medium using the digital pen 14. The digital pen 14 sends the read dot pattern to the client terminal 12.

The client terminal 12 transmits an additional contents read instruction containing an ID of a user, who operated the client terminal 12, and the dot pattern obtained by the digital pen 14 to the server 11.

On receiving the additional contents read instruction from the client terminal 12, the server 11 obtains the user ID contained in the received read instruction and obtains a tag ID from the dot pattern ID contained in the received read instruction (S111).

The server 11 identifies an object ID 212 corresponding to the obtained tag ID 211 by referring to the tag ID/object ID correspondence table 21 using the obtained tag ID. Then, the server 11 judges whether the user ID obtained in step S111 is contained as the read user ID 244B by referring to the object information 22 using the identified object ID (S112).

When it is found as a result of the judgment that the identifier of the user, who instructed the reading, is contained as the read user ID 224B, this means that the user has a right to read the additional contents, so the server 11 identifies the print information 23 from the print ID 225 and reads the print contents 233. Also, the server 11 identifies the additional contents information 24 from the contents ID 226 and reads the additional data 243. Further, the server 11 identifies the stroke information from the stroke ID 227 and reads the stroke information 27. Still further, the server 11 searches for the history information 26 using the object ID and reads the history information 26 for the medium (S113).

Then, the server 11 transmits the read print contents, additional data, stroke information, and history information to the client terminal 12. On receiving the print contents, additional data, stroke information, and history information, the client terminal 12 displays the received data on the data display unit (S114).

It should be noted that the client terminal 12 displays the print contents, additional data, stroke information, and history information in this embodiment but only a part of these information may be displayed.

In this case, the print contents and the stroke information are displayed so that they are superimposed on an image of the medium. It is possible for the user to confirm whether the information shown on the medium is authentic by comparing the information shown on the surface of the medium and the information displayed by the client terminal 12 with each other. In addition, it is possible for the user to see detailed information (additional data) relating to the information shown on the medium.

On the other hand, when it is not found in step S112 that the identifier of the user, who instructed the reading, is contained as the read user ID 224B, this means that the user does not have a right to read the additional contents, so the server 11 notifies the client terminal 12 that the user does not have such a right. On receiving the notification that the user does not have an additional contents read right, the client terminal 12 displays, on the data display unit, that the user does not have an additional contents read right. It should be noted that the notification that the user does not have a read right may be issued to the user by vibrating the digital pen 14 and/or emitting a warning sound from the digital pen 14 (S115).

After that, the server 11 creates the history information 26 in which “read” has been recorded as the operation kind 265 (S116). It should be noted that when the user does not have a read right and has failed in reading the additional contents, the history information 26, in which “failure” has been recorded as the operation result 267, is generated.

It should be noted that the read processing shown in FIG. 13 is based on the assumption that a link between the tag ID and the used object ID is valid but when information has been erased from the medium and the link between the tag ID and the used object ID has been removed, in the read processing shown in FIG. 13, it is impossible to read the information indicated on the medium and the information relating to the information indicated on the medium.

In this case, the user designates the tag ID and a search target time. The server 11 extracts an object ID 220, which corresponds to a tag ID 221 that is the same as the designated tag ID and also corresponds to a start date and time 222 and an end date and time 223 between which the designated time is contained, by referring to the object information 22. Then, like in step S113 described above, the server 11 reads the print information 23, additional contents information 24, stroke information 27, and history information 26.

In this case, when there is no object ID corresponding to the search target time designated by the user, the server 11 notifies the user that there is no corresponding result.

FIG. 14 is a flowchart of tag write processing according to the first embodiment.

First, a user writes information, such as characters, on a surface of a medium using the digital pen 14. When touching the medium, the digital pen 14 reads a dot pattern printed on the surface of the medium and identifies the medium on which the characters are to be written. In addition, the digital pen 14 obtains strokes of the characters or the like written by the user on the medium.

The client terminal 12 transmits an ID of the user who operated the client terminal 12, the dot pattern obtained by the digital pen 14, and a write notification of stroke information obtained by the digital pen 14 to the server 11.

On receiving the write notification from the client terminal 12, the server 11 obtains the user ID contained in the write notification and obtains a tag ID from the dot pattern ID contained in the write notification (S121).

The server 11 identifies an object ID 212 corresponding to the tag ID 211 by referring to the tag ID/object ID correspondence table 21 using the obtained tag ID. Then, the server 11 judges whether the user ID obtained in step S121 is contained as a write user ID 224C by referring to the object information 22 using the identified object ID (S122).

When it is found as a result of the judgment that the identifier of the user who performed the writing is contained as the write user ID 224C, this means that the user has a right to change information indicated on the medium, so the server 11 generates the stroke information 27 of the strokes obtained by the digital pen 14 and records an identifier of the generated stroke set information as the stroke ID 227 (S 123). In this case, if necessary, the server 11 may add the additional contents information 24 concerning the written information.

In this case, billing information concerning transfer of a commodity, to which the medium is affixed, may be contained in the added additional information. In other words, through annotation (of a check mark or a signature) in a predetermined area on the medium by the user, billing approval with respect to the user is requested. Then, through annotation into a predetermined area, a bill payment obligation is imposed on the user.

On the other hand, when it is not found in step S122 that the identifier of the user, who performed writing, is contained as the write user ID 224C, this means that the user does not have a right to change the information indicated on the medium, so the server 11 notifies the client terminal 12 that the user does not have such a right. On receiving the notification that the user does not have a write right, the client terminal 12 displays, on the data display unit, that the user does not have a right to write characters or the like. It should be noted that the notification that the user does not have a write right may be issued to the user by vibrating the digital pen 14 and/or emitting a warning sound from the digital pen 14 (S124).

After that, the server 11 creates the history information 26 in which “read” has been recorded as the operation kind 265 (S125). It should be noted that when the user does not have a write right, the history information 26, in which “failure” has been recorded as the operation result 267, is generated.

FIG. 15 is a flowchart of tag erasing processing according to the first embodiment.

First, a user operates the client terminal 12 to input an instruction to erase information shown on a surface of a medium. In this case, the user designates a medium to be erased, by reading a dot pattern printed on the surface of the medium with a touch of the medium using the digital pen 14. The digital pen 14 sends the read dot pattern to the client terminal 12.

The client terminal 12 transmits an erasing instruction containing an ID of the user, who operated the client terminal 12, and the dot pattern obtained by the digital pen 14 to the server 11.

On receiving the erasing instruction from the client terminal 12, the server 11 obtains the user ID contained in the received erasing instruction and obtains a tag ID from the dot pattern ID contained in the received erasing instruction (S131).

The server 11 identifies the object ID 212 corresponding to the obtained tag ID 211 by referring to the tag ID/object ID correspondence table 21 using the obtained tag ID. Then, the server 11 judges whether the user ID obtained in step S131 is contained as the write user ID 224C by referring to the object information 22 using the identified object ID (S132).

When it is found as a result of the judgment that the identifier of the user, who instructed the reading, is contained as the write user ID 224C, this means that the user has a right to change the information indicated on the medium, so it is possible for him/her to erase the information shown on the surface of the medium. Therefore, the server 11 identifies the object information 22 from the tag ID and records the end date and time 223. In addition, the server 11 changes the used object ID 212 on the tag ID/object ID correspondence table 21 to “unused” (S133). Following this, the information shown on the surface of the medium is erased by the printer 13. As already mentioned, it is possible to display characters on the surface of the medium used in this embodiment and erase them from the medium surface based on a cooling speed after heating.

On the other hand, when it is not found in step S132 that the identifier of the user, who instructed the erasing, is contained as the write user ID 224C, this means that the user does not have a right to change the information indicated on the medium, so the server 11 notifies the client terminal 12 that the user does not have a right to erase the information shown on the surface of the medium. On receiving the notification that the user does not have an erase right, the client terminal 12 displays, on the data display unit, that the user does not have a right to erase the information shown on the surface of the medium. It should be noted that the notification that the user does not have an erase right may be issued to the user by vibrating the digital pen 14 and/or emitting a warning sound from the digital pen 14 (S135).

After that, the server 11 creates the history information 26 in which “erase” has been recorded as the operation kind 265 (S116). It should be noted that when the user does not have an erase right and has failed in erasing information, the history information 26, in which “failure” has been recorded as the operation result 267, is generated.

As described above, in the first embodiment of this invention, it becomes possible to manage a medium and electronic information concerning the medium by associating them with each other. In other words, when information is printed on the medium, a tag ID and a used object ID are linked with each other. Also, when the information is erased from the medium, the link between the tag ID and the used object ID is removed. As a result, it becomes possible to manage the medium and the electronic information concerning the medium by associating them with each other.

Also, by comparing the information printed on the medium and the electronic information held at the server with each other, it becomes possible to confirm whether the information currently shown on the medium is authentic.

Further, a user's right is confirmed at the time of writing of information onto the medium, so the electronic information will not be tampered by an unauthorized user.

Here, a method of data communication between the server 11 and the client terminal 15 will be described.

The server 11 and the client terminal 15 perform data communication through the network 18. Fundamentally, from the viewpoint of security, it is preferable that the network 18 uses a private line. However, there is a case where a network opened to the public, such as the Internet, is used with consideration given to cost or the like. Therefore, it is preferable that even when a network opened to the public, such as the Internet, is used, it is possible to perform secure data communication. As data communication means therefor, two means will be described, one of which is encryption communication means using a common key and the other of which is public key/secret key encryption communication means using a public key and a secret key.

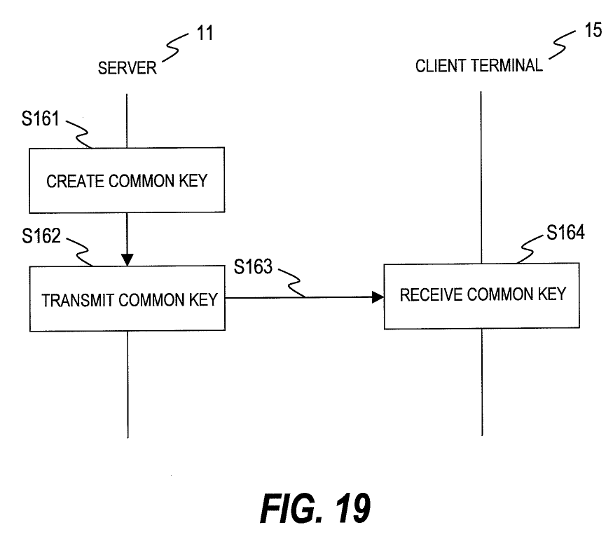

The encryption communication means based on a common key is a method with which data is encrypted/decrypted at each of a data transmission source and a data reception destination using the same common key. Therefore, at the server 11 and the client terminal 15, it is required to perform processing shown in FIG. 19 in advance as a preparation for communication.

First, a common key is created at the server 11 (S161). After that, the server 11 distributes the created common key to each client terminal 15 (S162 to S164). As a method of distributing the common key, for instance, there is a method with which common key information is copied to a recording medium, such as a flexible disk (FD) or a compact disc (CD), on a server 11 side and the common key is copied to each client terminal 15 from the medium recording the common key information.

In data transmission from the server 11 to the client terminal 15 and data transmission from the client terminal 15 to the server 11 using the common key, encryption is performed using the common key at the transmission source and decryption is performed using the common key at the reception destination. This makes it possible to perform secure data communication. As an algorithm for the encryption, it is possible to use a known encryption system such as the Data Encryption Standard (DES).

In the case of the common key, however, there is a danger that once the common key has been leaked, every data communication between the server 11 and the client terminal 15 will be intercepted. Therefore, as another encryption communication means, a case will be described below in which the encryption communication means using a public key and a secret key is applied.

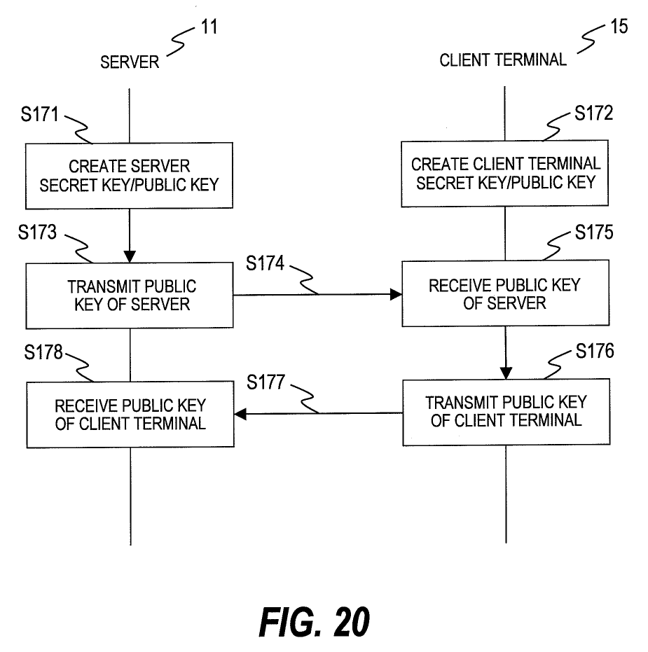

The encryption communication means using a public key and a secret key in this embodiment is a method with which data is encrypted at a data transmission source using a public key of a data reception destination and the data is decrypted at the data reception destination using a secret key of the data reception destination. Therefore, at the server 11 and the client terminal 15, it is required to perform processing shown in FIG. 20 in advance as a preparation for communication.

First, at each of the server 11 and the client terminal 15, a secret key and a public key are created (S171, S172). Next, the public key of the server 11 is distributed to the client terminal 15 (S173 to S175). As a method of distributing the public key, it is possible to use a method with which the key is copied to a medium like in the case of the common key encryption communication means described above. Also, it is possible to use a method with which information of the server public key is transmitted as it is through the network 18.

Next, the public key of the client terminal 15 is distributed to the server (S176 to S178). As a method of distributing the public key, it is possible to use any of the methods described above for the server public key. Also, it is possible to use a method with which data of the public key of the client terminal 15 is encrypted using the public key of the server 11 received in advance and the encrypted public key is transmitted to the server 11 through the network 18. As an algorithm for the encryption, it is possible to use a general encryption system using a public key and a secret key such as RSA.

As a result of the public key exchange between the server 11 and each client terminal 15, data transferred from the server 11 to the client terminal 15 is encrypted using the public key of the client terminal and is decrypted using the secret key of the client terminal. On the other hand, data transferred from the client terminal 15 to the server 11 is encrypted using the public key of the server and is decrypted using the secret key of the server. This makes it possible to perform secure data communication.

It should be noted that the distribution of the public key of the server 11 (S173 to S175) and the distribution of the public key of the client terminal 15 (S176 to S178) may be performed in a reverse order.

With one of the two encryption means described above, it becomes possible to transmit data concerning this invention securely.

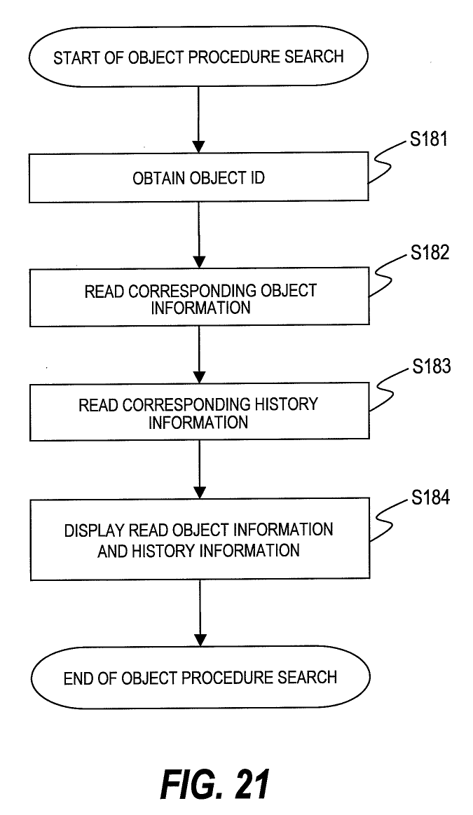

Finally, processing for searching for a series of procedures concerning an object, such as attachment of a tag to the object, reading of data from the tag, and writing of data to the tag, will be described using FIG. 21.

First, a user designates an object that is a search target and obtains an object ID (S181). When a tag is affixed to the object, an object ID 212 is obtained from an ID of the affixed tag by referring to the tag ID/object ID correspondence table 21. It should be noted that when a link between the object and the tag is already removed, the user directly designates an object ID or the user designates a tag ID and a search target time and an object ID 220 is obtained from the designated information by referring to the object information 22.

Next, the object information 22 corresponding to the object ID is searched for and contents of the found object information 22 are read (S182). In addition, the history information 26 corresponding to the object ID is searched for by referring to the operation object ID 263 of the history information 26 and contents of the found history information 26 are read (S183).

Finally, the read object information 22 and history information 26 are presented to the user (S184). Through this object procedure search processing, it is possible to obtain a history of a series of operation with respect to a target object. As a result, it becomes possible to realize the traceability of an object.

### Second Embodiment

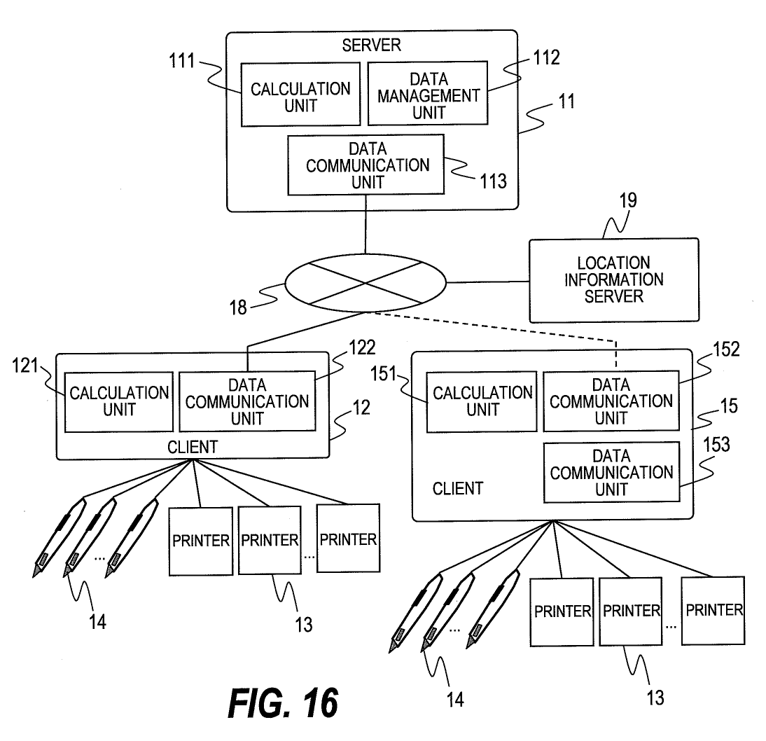

FIG. 16 is a block diagram of an information management system according to a second embodiment.

The information management system according to the second embodiment differs from the information management system according to the first embodiment described above in that in addition to an online client terminal 12 connected with a network 18, a local client terminal 15 that is not connected with the network 18 is provided. It should be noted that each construction that is the same as a construction in the first embodiment is given the same reference numeral and the detailed description thereof will be omitted.

The information management system according to the second embodiment includes a server 11, client terminals 12 and 15, digital pens 14, a network 18, and a location information server 19.

The server 11, the client terminal 12, and the location information server 19 are connected to one another through the network 18. In ordinary cases, the local client terminal 15 is not connected to the network 18.

In other words, the online client terminal 12 is capable of communicating with the server 11 at all times. On the other hand, the local client terminal 15 is incapable of communicating with the server 11 in ordinary cases but is connected to the network 18 as necessary and becomes capable of communicating with the server 11.

The client terminal 15 and each digital pen 14 are connected in a wireless manner based on Bluetooth, a wireless LAN, a mobile telephone system, infrared rays, or the like. Alternatively, they may be connected in a wired manner using a universal serial bus (USB) protocol or the like.

The client terminal 15 includes a calculation unit 151, a data communication unit 152, a data management unit 153, a pen input unit (not shown), an operation input unit (not shown), and a data display unit (not shown). The calculation unit 151 includes a CPU and a memory. The CPU invokes and executes various programs, thereby performing computation concerning processing carried out at the client terminal 15.

The data communication unit 152 is a network interface and is, for instance, a LAN card that is capable of performing communication using a TCP/IP protocol. With this construction, when connected with the network 18, the client terminal 15 becomes capable of communicating with the server 11.

The data management unit 153 is constructed by a nonvolatile storage medium (magnetic disk drive, for instance) and stores the various programs executed at the calculation unit 151. Also, the storage unit 153 stores the tag ID/object ID correspondence table 21 shown in FIG. 4, object information 22 shown in FIG. 5, print information 23 shown in FIG. 6, additional contents information 24 shown in FIG. 7, user information 25A and the like shown in FIG. 8A to FIG. 8C, history information 26 shown in FIG. 9, and stroke information 27 shown in FIG. 11B. These tag ID/object ID correspondence table 21, object information 22, print information 23, additional contents information 24, history information 26, and stroke information 27 stored at the client terminal 15 do not match their corresponding information held at the server 11 under a state where the client terminal 15 is not connected with the server 11.

In other words, when any operation is performed at the local client terminal 15, the client terminal 15 generates an object ID according to its own rule. Therefore, there is a case where different object IDs are associated with the same tag ID.

The pen input unit is connected with each digital pen 14 in a wireless manner (based on Bluetooth or a wireless LAN, for instance) or a wired manner (using a USB protocol, for instance) and collects information about coordinates and the like obtained by the digital pen 14. It should be noted that the pen input unit and the data communication unit 152 may be the same interface.

The operation input unit is a keyboard, for instance, and is used by a user to input information. The data display unit is constructed using a liquid crystal display, for instance, and displays information concerning a medium obtained from the server 11.

In FIG. 16, one online client terminal 12 and one local client terminal 15 are illustrated but multiple online client terminals 12 and multiple local client terminals 15 may be provided. In other words, it may be made possible to make a switching as to whether a segment constructed by multiple local client terminals 15 is connected to the network 18.

In ordinary cases, the local client terminal 15 is not connected to the network 18 and therefore is incapable of communicating with the server 11. Consequently, when operation on a medium is performed, a new object ID is generated without cooperating with the server 11, so there is a case where an object ID that is different from that of the server 11 is linked to the same tag ID. In other words, the local client terminal 15 is incapable of obtaining a global object ID unless inquiring the server 11.

Therefore, when the client terminal 15 is connected to the network 18, there occurs a problem that there are multiple tag ID-to-object ID links. Consequently, there is a necessity to perform object ID conversion when the client terminal 15 is connected to the network 18.

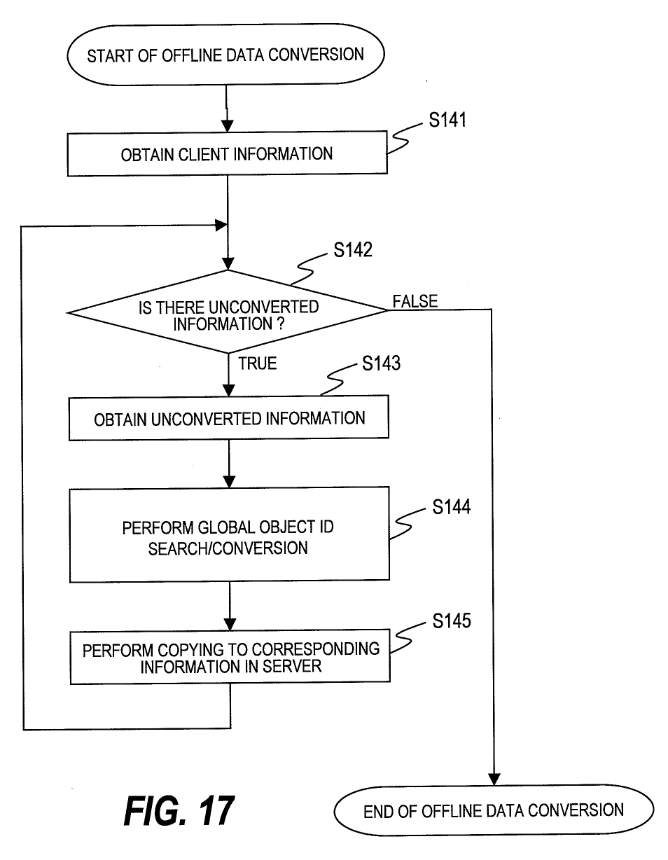

FIG. 17 is a flowchart of offline data conversion processing according to the second embodiment.

The offline data conversion processing is carried out at the server 11 when the local client terminal 15 is connected to the network 18 and communicates with the server 11.

On detecting connection of the local client terminal 15, the server 11 obtains information accumulated in the local client terminal 15 (S141). Then, the server 11 judges whether any local object IDs exist in the information obtained from the client terminal 15 (S142). Therefore, it is sufficient that the local client terminal 15 and the server 11 generates object IDs using different systems.

When no local object ID exists in the information obtained from the client terminal 15, this means that conversion of every local object ID in the information obtained from the client terminal 15 has been completed, so the server 11 ends this offline data conversion processing.

On the other hand, when any local object IDs exist in the information obtained from the client terminal 15, the server 11 obtains information concerning each unconverted object ID (S143). Then, the server 11 searches for a global object ID and converts the local object ID into the global object ID (S144).

After that, various information held at the client terminal 15 is copied to the server 11 (S145).

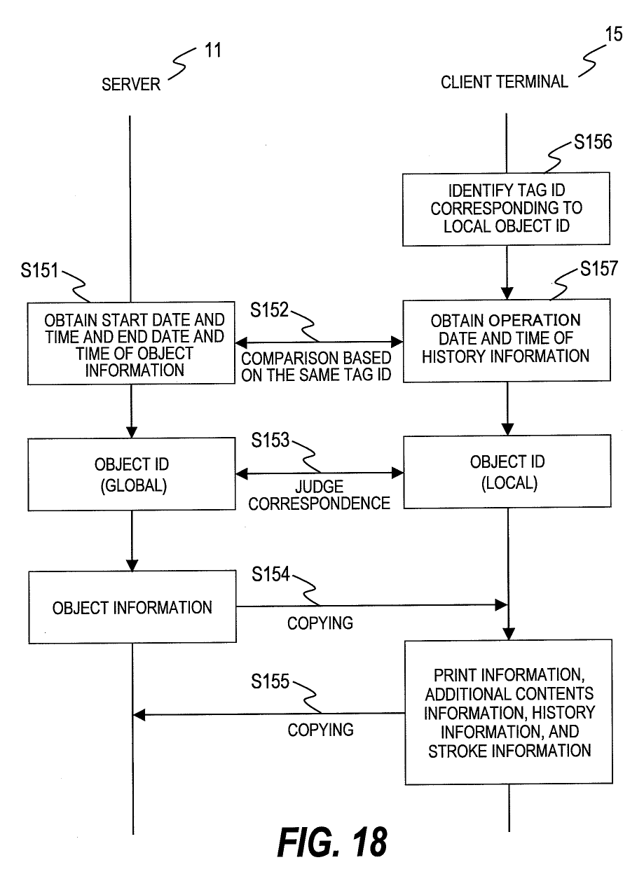

FIG. 18 is a detailed flowchart of the offline data conversion processing according to the second embodiment and shows the details of the processing in steps from S143 to S145 in FIG. 17.

The client terminal 15 identifies a tag ID 211 corresponding to a local object ID 212 by referring to the object information 22 held at itself (S156). Also, the client terminal 15 obtains a operating date and time 261 corresponding to the local object ID 264 by referring to the history information 26 held at itself (S157).

On the other hand, the server 11 identifies an object ID 212 using the tag ID identified at the client terminal 15 by referring to the object information 22 held at itself. Then, the server 11 obtains the start date and time 222 and the end date and time 223 by referring to the object information 22 using the identified object ID (S151).

After that, the operating date and time 261 obtained from the local client terminal 15 and the start date and time 222 and the end date and time 223 held at the server 11 are compared with each other (S152). Then, when the operating date and time 261 is between the start date and time 222 and the end date and time 223 corresponding to the same tag ID, it is judged that the local object ID and the global object ID held at the server 11 correspond to the same object (S153).

When a result of this object ID correspondence judgment is affirmative, the object information 22 held at the server 11 is copied to the object information 22 held at the client terminal 15 (S154). As a result, the local object ID is converted into the global object ID.

After that, the print information 23, additional contents information 24, history information 26, and stroke information 27 held at the client terminal 15 are copied to their corresponding information held at the server 11 (S155).

As described above, according to the second embodiment of this invention, even in a system in which the client terminal 15 is not connected with the server 11 at all times, it becomes possible to appropriately manage a medium and electronic information concerning the medium. Also, when the client terminal 15 is connected to the server 11, an identifier (object ID) of information printed on the medium is converted, so it becomes possible to integrate even electronic information generated through an operation by the client terminal 15 alone into electronic information of the server 11.

While the present invention has been described in detail and pictorially in the accompanying drawings, the present invention is not limited to such detail but covers various obvious modifications and equivalent arrangements, which fall within the purview of the appended claims.

What is claimed is:

1. An information management method for managing information concerning a medium executed in an information management system including: the medium capable of representing on a surface thereof object information that is contents concerning an object; a management apparatus for managing a history of operation on the medium; and a printing apparatus for representing the object information on the medium and erasing the represented object information from the medium,
the information management method comprising:
holding, by the management apparatus, a correspondence among an identifier of the medium, the object information represented on the medium, and a valid period of the object; and
recording, by the management apparatus, a start of the valid period of the object when the printing apparatus represents the object information on the medium.

2. The information management method according to claim 1, further comprising:
holding, by the management apparatus, the object information;
searching, by the management apparatus, object information held by the management apparatus for object information which corresponds to the identifier of the medium when the valid period of the object has not ended; and
providing, by the management apparatus, the found object information.

3. The information management method according to claim 1, further comprising:
holding, by the management apparatus, the object information;
searching, by the management apparatus, object information held by the management apparatus for object information in which a search target time is included in the valid period and which corresponds to the identifier of the medium when the valid period of the object has ended; and
providing, by the management apparatus, the found object information.

4. The information management method according to claim 1, further comprising removing, by the management apparatus, a correspondence between the identifier of the medium and the object information when the printing apparatus erases the object information represented on the medium.

5. The information management method according to claim 1, further comprising ending, by the management apparatus, the valid period of the object when the printing apparatus erases the object information represented on the medium.

6. The information management method according to claim 1,
wherein the information management system further includes a coordinate providing device for identifying a location on the medium, and
wherein the information management method further comprises:
providing the medium with information for allowing the coordinate providing device to identify the location on the medium;
obtaining, by the coordinate providing device, the location on the medium and a time at which the location is identified by referring to the information provided to the medium;
generating, by the management apparatus, stroke information on each stroke applied to the medium based on the location on the medium and the time obtained by the coordinate providing device; and
holding, by the management apparatus, the generated stroke information in association with an identifier of the object information.

7. The information management method according to claim 1,
wherein the information management system further includes a first terminal that is coupled to the management apparatus at all times and a second terminal that is coupled to the management apparatus when it is necessary, and
wherein the information management method further comprises:
holding, by the management apparatus, a correspondence relation among the identifier of the medium manipulated by the first terminal, a first identifier of the object information represented on the medium, and the valid period of the object;
holding, by the second terminal, a correspondence between the identifier of the medium manipulated by the second terminal and a second identifier of the object information represented on the medium; and
converting, by the management apparatus, the second identifier of the object information and recording a correspondence between the converted identifier of the object information and the identifier of the medium when the second terminal is coupled to the management apparatus.

8. The information management method according to claim 7, further comprising:
holding, by the second terminal, a operation time at which the operation on the medium has been performed by the second terminal;
checking, by the management apparatus, the operation time at which the medium is operated by the second terminal and the valid period of the object held by the management apparatus each other when the second terminal is coupled to the management apparatus; and
converting, the second identifier of the object information held by the second terminal into the first identifier of the object information held by the management apparatus when the same medium identifier is used and the operation time is included in the valid period.

9. The information management method according to claim 1, further comprising using one of a common key encryption and a public key/secret key encryption for data communication between the management apparatus and a terminal.

10. The information management method according to claim 1, further comprising searching, by the management apparatus, for object information corresponding to an object designated by a user and operation history information corresponding to the designated object and showing the found information to the user.

11. An information management system for managing information concerning a medium, comprising:
the medium capable of representing on a surface thereof object information;
a management apparatus for managing a history of operation on the medium; and
a printing apparatus for representing the object information on the medium and erasing the represented object information from the medium,
wherein the management apparatus is configured to:
hold an identifier of the medium, the object information, and a valid period of the information represented on the medium; and
record a start of the valid period of the object when the printing apparatus represents the object information on the medium.

12. The information management system according to claim 11, wherein the management apparatus is further configured to:
hold the object information;
search, when the valid period of the object has not ended, object information held by the management apparatus for object information which corresponds to the identifier of the medium; and
provide the searched object information.

13. The information management system according to claim 11, wherein the management apparatus is further configured to:
hold the object information,
search, when the valid period of the object has ended, object information held by the management apparatus for object information in which a search target time is included in the valid period and which corresponds to the identifier of the medium; and
provide the found object information.

14. The information management system according to claim 11, wherein the management apparatus removes, when the printing apparatus erases the object information represented on the medium, a correspondence between the identifier of the medium and the object information.

15. The information management system according to claim 11, wherein the management apparatus ends, when the printing apparatus erases the object information represented on the medium, the valid period of the object.

16. The information management system according to claim 11, further comprising a coordinate providing device for identifying a location on the medium, wherein:
the medium is provided with information for allowing the coordinate providing device to identify the location on the medium;
the coordinate providing device obtains the location on the medium and a time at which the location is identified by referring to the information provided to the medium;
the management apparatus generates stroke information on each stroke applied to the medium based on the location on the medium and the time obtained by the coordinate providing device; and
the management apparatus holds the generated stroke information in association with an identifier of the object information.

17. The information management system according to claim 11 further comprising:
a first terminal that is coupled to the management apparatus at all times; and
a second terminal that is coupled to the management apparatus when it is necessary, wherein:
the management apparatus holds a correspondence relation among the identifier of the medium manipulated by the first terminal, a first identifier of the object information represented on the medium, and the valid period of the object;
the second terminal holds a correspondence between the identifier of the medium manipulated by the second terminal and a second identifier of the object information represented on the medium; and
the management apparatus converts, when the second terminal is coupled to the management apparatus, the second identifier of the object information and recording a correspondence between the converted identifier of the object information and the identifier of the medium.

18. The information management system according to claim 17, wherein:
the second terminal holds a operation time at which the operation on the medium has been performed by the second terminal; and
the management apparatus checks, when the second terminal is coupled to the management apparatus, the operation time at which the medium is operated by the second terminal and the valid period of the object held by the management apparatus each other; and
the management apparatus converts, when the same medium identifier is used and the operation time is included in the valid period, the second identifier of the object information held by the second terminal into the first identifier of the object information held by the management apparatus.

19. The information management system according to claim 11, wherein the management apparatus and a terminal use one of a common key encryption and a public key/ secret key encryption for data communication between the management apparatus and a terminal.

20. The information management system according to claim 11, wherein the management apparatus searches for object information corresponding to an object designated by a user and operation history information corresponding to the designated object and showing the found information to the user.
